(19) United States
(12) Patent Application Publication
(10) Pub. No.: US 2022/0226680 A1
(43) Pub. Date: Jul. 21, 2022

(54) EXPLOSION-MONITORING SYSTEM OF A COMMINUTING INSTALLATION, COMMINUTING INSTALLATION AND METHOD FOR OPERATING AN EXPLOSION-MONITORING SYSTEM

(71) Applicant: DIEFFENBACHER GMBH MASCHINEN- UND ANLAGENBAU, Eppingen (DE)

(72) Inventor: Felix HOFMANN, Eppingen (DE)

(73) Assignee: DIEFFENBACHER GMBH MASCHINEN- UND ANLAGENBAU, Eppingen (DE)

(21) Appl. No.: 17/614,060

(22) PCT Filed: May 25, 2020
(86) PCT No.: PCT/EP2020/064471

§ 371 Date: Nov. 24, 2021

(30) Foreign Application Priority Data
May 26, 2019 (DE) 10 2019 114 036.6

(51) Int. Cl. A62C 3/00; A62C 3/04

(52) U.S. Cl. CPC A62C 3/002; A62C 3/04

(57) ABSTRACT

An explosion control system of a comminuting installation for materials is provided for controlling unintended releases of energy by the materials. Additionally, a comminuting installation and a method for operating an explosion control system are provided. The explosion control system has at least one pressure control device. The at least one pressure control device allows for control of the propagation of pressure increases as a result of releases of energy by materials in the comminuting installation.

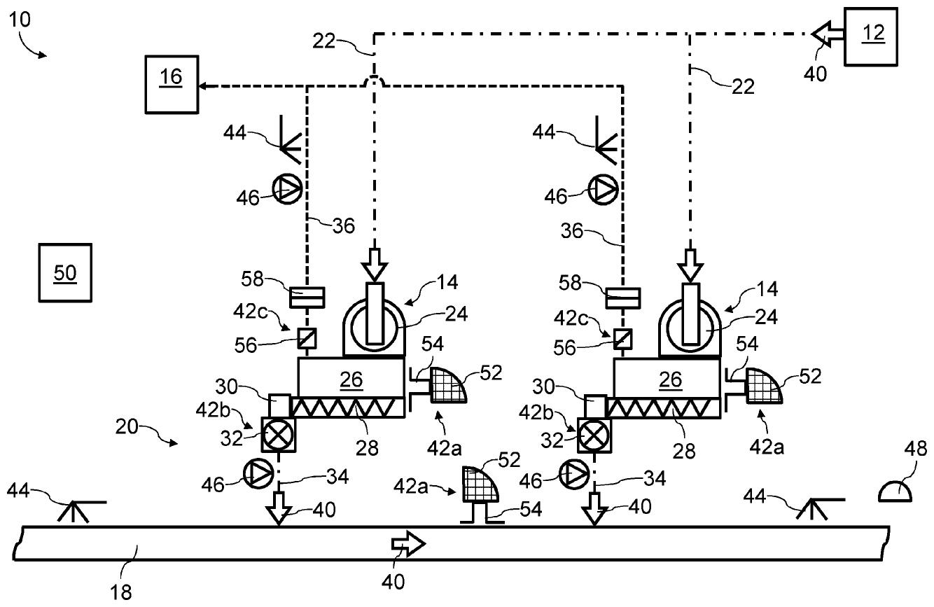

### CROSS-REFERENCE TO RELATED PATENT APPLICATIONS

This application is a 371 national phase entry of International Patent Application No. PCT/EP2020/064471, filed May 25, 2020, which claims priority to German Patent Application No. 102019114036.6, dated May 26, 2019, the contents of which are incorporated herein in their entirety by reference.

### BACKGROUND

A device for detecting and notification of optical fire phenomena for moving dust-like particles is known from DE 20 2005 014 771 U1. The device can be used wherever moving organic dust particles are present, where increased fire or explosion protection must be ensured during the transport thereof. This can be the case during transport of dust particles in pipes or cyclone units in the chipboard industry, textile industry, recycling and milling industry, furniture manufacturing, where wood-like particles are extracted. Processing machines with pneumatic suction and conveying equipment, such as those found, among others, in the wood processing and textile, recycling, food, feed, leather, rubber and chemical industries, pose fire hazards that require special protective measures. Sparks caused by processing machines and contaminants, such as metal bits and stones in the conveying equipment, reach downstream equipment via the conveying lines. Here, they can cause smoldering fires that develop unnoticed, covered by the thereinafter following conveyed material. Large-scale fires or dust explosions often result. Spark extinguishing systems were developed to prevent this. These spark extinguishing systems are usually sensors that are coupled with an extinguishing center and an automatic extinguishing system.

### SUMMARY

The invention relates to an explosion control system of a comminuting installation for materials for controlling unintended releases of energy by materials.

Furthermore, the invention relates to a comminuting installation for materials
with at least one comminuting device,
with at least one material supply line for feeding materials to be comminuted to the at least one comminuting device,
with at least one conveying removal line for removal of comminuted materials from the at least one comminuting device
and with at least one explosion control system for controlling unintended releases of energy by materials.

The invention also relates to a method for operating an explosion control system of a comminuting installation for materials, in which any unintended releases of energy by materials are controlled.

The invention is based on the task to design an explosion control system, a comminuting installation and a method of the type mentioned here above, in which the consequences of unintended releases of energy by materials can be relieved.

This task is solved in the explosion control system in that the explosion control system comprises at least one pressure control device with which the propagation of pressure increases due to releases of energy by materials in the comminuting installation can be controlled.

Unintentional releases of energy by materials in the sense of the invention are understood to be sparks, fires, explosions and/or other events, in particular pressure-increasing events. Uncontrolled unintended releases of energy can lead to damage in the comminuting installation and also represent a danger to persons who are present.

According to the invention, all unintended releases of energy are relieved in a controlled manner with the at least one pressure control device. In this way, the consequences of unintended releases of energy, in particular required repair and maintenance measures on the comminuting installation and the danger to persons, are relieved.

With the aid of the at least one pressure control device, unintended releases of energy can be relieved in a controlled manner in areas of the comminuting installation in which the consequences of the unintended releases of energy can be minimized.

Advantageously, the areas in which unintended releases of energy are relieved in a controlled manner with the at least one pressure control device can be areas in which any consequential damage can be minimized. In particular, no components or only resilient components are arranged in the relevant areas. Alternatively, or additionally, the areas in which unintended releases of energy can be controlled with the at least one pressure control device can be as easily accessible as possible. In this way, repair and maintenance work can be carried out there more easily.

Due to the controlled reduction of the unintended releases of energy according to the invention, it is not absolutely necessary to use extinguishing agents to prevent or fight any sparks, fires and/or explosions, as is the case with devices known from prior art. The use of extinguishing agents has the disadvantage that the comminuting installation requires costly maintenance after the use of extinguishing agents. Furthermore, the extinguishing system that is used must be put back into operation and tested. In particular, the extinguishing agent must be replenished or renewed. This is costly and time-consuming. During such repair and maintenance work, the comminuting installation must be stopped. With the help of the invention, on the other hand, an explosion can be allowed to occur and can be relieved in a controlled manner, such that the consequential damage is lesser than with the use of extinguishing agents, especially in central areas of the comminuting installation. The comminuting installation can be reused more quickly without major maintenance.

The materials can be of plant origin, in particular wood, waste wood, straw and/or renewable agricultural products, or plastic, composite material or the like.

Protection from explosions and fires is urgently required, in particular in comminution of waste wood. Waste wood is particularly dry, which creates more dust particles during comminution than moister fresh wood. Therefore, there is a greater risk of explosion and fire when comminuting waste wood than comminuting fresh wood. Furthermore, waste wood may contain contaminants such as metal bits, stones or the like. In particular during the comminuting process or when conveying the comminuted materials, the contaminants can cause sparks, which can easily ignite the comminuted waste wood and dust particles.

The comminuting installation can be used to comminute the materials into chips, fibers, wood chips, shredded material or the like. The comminuted materials can be used as pressed material or grit, from which pressed plates can be made.

Advantageously, the comminuting installation can be combined with an installation for the production of material plates, in particular press plates. The comminuting installation can be used to provide the comminuted material, in particular the pressed material, from which the material plates are produced, in particular pressed plates.

In an advantageous embodiment, at least one pressure control device may comprise or consist of at least one pressure relief device. With at least one pressure relief device, an increase in pressure in the comminuting installation as a result of a release of energy by materials, in particular an explosion, can be relieved in a controlled manner.

Advantageously, at least one pressure relief device can be arranged in the area of a comminuting device, in particular downstream of the comminuting device in the direction of conveyance of the materials, in particular at a collection space. In this way, the comminuting device can be protected in the event of an explosion downstream of the comminuting device.

Advantageously, at least one pressure relief device can be arranged in the region of at least one exhaust air duct of at least one comminuting device, in particular at a collection space from which the at least one exhaust air duct leads out. In this way, the exhaust air duct can be protected against explosions during normal operation.

Advantageously, at least one pressure relief device can be arranged in the area of a conveying removal line for comminuted materials. In this way, the conveying removal line can be protected in case of an explosion in the conveying removal line.

In a further advantageous embodiment, at least one pressure control device may comprise or consist of at least one expansion box and/or at least one rupture disc. Expansion boxes and rupture discs serve to relieve pressure and may therefore at least co-form corresponding pressure relief devices.

With an expansion box, the speed of pressure propagation can be relieved and limited. In this way, the pressure propagation in the comminuting installation can be limited.

With rupture discs, the comminuting installation can be protected against damaging overpressure. Rupture discs form a type of predetermined breaking point. Rupture discs can easily be replaced.

Advantageously, at least one rupture disc can be arranged in an easily accessible area of the comminuting installation. In this way, a destroyed rupture disc can easily be switched out.

Advantageously, at least pressure control devices, in particular a pressure relief device, can have at least one wire mesh which separates an area in which a pressure increase, in particular an explosion, can potentially take place from a compensation area, in particular the surrounding environment. Pressure equalization can be permitted with the aid of the at least one wire mesh. Thereby, the at least one wire mesh can prevent sparks or flames from leaving the area with the pressure increase through the at least one wire mesh. With the aid of at least one wire mesh, flameless pressure relief can be realized. At least one wire mesh can be part of an expansion box.

In a further advantageous embodiment, at least one pressure control device can be arranged downstream of a comminuting device in the direction of conveyance of the materials and/or at least one pressure control device can be arranged upstream of, on or in a conveying removal line for comminuted materials and/or at least one pressure control device can be arranged on, in or upstream of at least one exhaust air duct.

Downstream of the comminuting device, the materials are comminuted and therefore more susceptible to sparks. With the aid of a pressure control device downstream in the direction of conveyance of the materials of the comminuting device, it is possible that the comminuting device can be protected from pressure increases and/or sparks originating from an area downstream of the comminuting device.

During comminution, sparks can be caused in the comminuting device by contaminants, in particular by metal bits, stones or the like, which may be contained in the materials. With the aid of pressure control devices, areas of the comminuting installation downstream of the comminuting device, in particular a conveying removal line, can be protected from pressure increases and/or sparks coming from the comminuting device.

With a pressure control device downstream of, at or in a conveying removal line for comminuted materials, it is possible that the propagation of a pressure increase, sparks and/or fire in the conveying removal line can be controlled, in particular prevented or limited.

With a pressure control device at, in or downstream of at least one exhaust air duct, the propagation of a pressure increase, sparks and/or fire in the at least one exhaust air duct can be prevented. Thus, if necessary, an explosion or fire can be prevented from spreading via the at least one exhaust air duct to other comminuting devices of the comminuting installation. In a further advantageous embodiment, at least one pressure control device may comprise or consist of at least one pressure guidance device with which the pressure increase in the comminuting installation can be guided in a controlled manner. In this way, an unintended pressure increase can be guided to areas that are less susceptible and/or are easier to maintain. The pressure increase can be kept away from areas that are more sensitive and/or are more difficult to maintain. Overall, the consequences of an unintentional pressure increase can thus be further relieved.

In a further advantageous embodiment, at least one pressure control device may comprise or consist of at least one compartmentalization device. With a compartmentalization device, areas of the comminuting installation can be compartmentalized and thus separated from other areas. In this way, areas of the comminuting installation, in which a pressure increase takes place, can be compartmentalized and unaffected areas can be protected.

In the case of a comminuting installation with multiple comminuting devices, the individual comminuting devices can be compartmentalized with appropriate compartmentalization devices. In the event of a pressure increase, in particular an explosion, in one of the comminuting devices, this can be compartmentalized from the other comminuting devices. This prevents the pressure increase from spreading. With the aid of the compartmentalization devices, the comminuting device can also be compartmentalized for maintenance purposes. In this way, individual comminuting devices can be serviced during operation of the other comminuting devices.

In a further advantageous embodiment, at least one pressure control device may comprise or consist of at least one compartmentalization device that can be controlled and/or at least one pressure control device may comprise or consist of at least one automatic-acting compartmentalization device. An automatic-acting compartmentalization device that can be controlled may be motor-actuated and/or manually-actuated. A motor-actuated compartmentalization device may be controlled by a corresponding control device, in particular a control center. In this way, the compartmentalization can automatically be activated, in particular if an unintended release of energy, in particular an increase in pressure and/or sparks, is detected with the aid of a suitable detection device.

An automatic-acting compartmentalization device may activate the compartmentalization itself, in particular due to a pressure difference in the event of a flashback, without the need for separate automatic or manual actuation.

In a further advantageous embodiment, at least one pressure control device may comprise or consist of at least one sluice and/or at least one pressure control device may comprise or consist of at least one flashback blocking device. Compartmentalization devices can be achieved with sluices and flashback blocking device.

Sluices can be controlled and thus opened or closed in a controlled manner.

Flashback blocking devices can be activated or deactivated automatically.

Advantageously, at least one sluice can be designed as a cellular wheel sluice. In the case of a cellular wheel sluice, the cellular wheel can be stopped in order to easily achieve compartmentalization.

Advantageously, at least one flashback blocking device may comprise a check valve. A check valve can be implemented in a simple and resilient manner.

In a further advantageous embodiment, at least one compartmentalization device of at least one pressure control device may be arranged downstream of at least one comminuting device in the direction of conveyance of the materials and/or at least one compartmentalization device of at least one pressure control device may be arranged upstream of at least one conveying removal line for comminuted materials in the direction of conveyance of the materials and/or at least one compartmentalization device of at least one pressure control device may be arranged in, at or upstream of an exhaust air duct for the at least one comminuting device and/or at least one compartmentalization device of at least one pressure control device can be arranged downstream of a pressure relief device in the direction of conveyance of the materials.

With at least one compartmentalization device downstream of at least one comminuting device, it is possible on the one hand that the at least one comminuting device can be protected from unintended releases of energy, in particular explosions and fires, in the direction of conveyance, downstream of the compartmentalization device. On the other hand, unintended releases of energy from the at least one comminuting device can be prevented from spreading into areas, in particular to a conveying removal line or an exhaust air duct, which are located downstream in the direction of conveyance.

With at least one compartmentalization device upstream of at least one conveying removal line, it can be prevented that unintended releases of energy from at least one comminuting device, in particular a collection space, spread into the at least one conveying removal line. In this way, if necessary, unintended releases of energy can be prevented from spreading via the at least one conveying removal line into other comminuting devices of the comminuting installation.

With at least one compartmentalization device in, at or upstream from an exhaust air duct, it can be prevented that unintended releases of energy can spread from the comminuting devices into the exhaust air duct. If the comminuting installation has several comminuting devices, their respective exhaust air ducts can be merged. With the aid of the at least one compartmentalization device, unintended releases of energy from one of the comminuting devices can be prevented from spreading via the exhaust air duct to the other comminuting devices.

With at least one compartmentalization device downstream of a pressure relief device, the area in which the unintended energy release takes place, in particular the pressure increase, for example by explosion, can be compartmentalized, whereas with the aid of the pressure relief device the unintended energy release, in particular the pressure increase, can be relieved in a controlled manner.

In a further advantageous embodiment, the explosion control system may comprise at least one extinguishing device for extinguishing releases of energy in the form of sparks and/or fire.

The at least one extinguishing device can be used to extinguish any sparks or fires in a targeted manner. In this way, the risk of explosion and fire can be further reduced.

Advantageously, extinguishing devices can be located in areas of the comminuting installation that are easily accessible and in which any extinguishing agents do not cause any damage. In this way, maintenance can be carried out more easily in the event that extinguishing agents are used.

In a further advantageous embodiment, the explosion control system may comprise at least one detection device for detecting unintended releases of energy by materials. The at least one detection device can be used to detect unintended releases of energy, in particular pressure increases, temperature increases, sparks, explosions or the like. As a result of the detection by the at least one detection device, suitable measures can be taken to control the unintended energy release, in particular the propagation of the pressure increase, in the comminuting installation. Thus, in particular, the explosion control system can be controlled accordingly, in particular with the aid of a control device, in particular a control center, in order to seal off the area of the unintended energy release and/or to carry out suitable extinguishing measures.

Advantageously, at least one detection device can have or consist of at least one (explosion) pressure detector, at least one temperature detector and/or at least one spark detector. In this way, unintended releases of energy by materials can reliably be identified.

In a further advantageous embodiment, at least one detection device may be arranged in the vicinity of at least one pressure control device and/or at least one extinguishing device. In this way, the corresponding pressure control devices and/or extinguishing device can be specifically activated at the location of the unintended energy release.

In a further advantageous embodiment, the explosion control system can have at least one control center. The explosion control system can be controlled by the at least one control center.

Thus, an unintended release of energy by materials can be better controlled.

The at least one control center can be functionally connected to a control of the comminuting installation. In this way, in the event of an unintentional release of energy, the comminuting installation or parts thereof can be controlled accordingly, if necessary stopped.

Moreover, the task of the comminuting installation is solved according to the invention in that the explosion control system comprises at least one pressure control device with which the propagation of pressure increases due to releases of energy by materials in the comminuting installation can be controlled.

In this way, the comminuting installation can be operated more safely overall. Furthermore, if necessary, individual comminuting devices of the comminuting installation can more easily be protected, in particular disconnected, for maintenance purposes and/or in the event of an unintended release of energy by materials.

Advantageously, at least one comminuting device may comprise a machining or cutting system. Materials can be comminuted with machining or cutting systems.

Advantageously, at least one comminuting device can be designed as a blade ring chipper. In this way, materials can be comminuted to chips.

Advantageously, the comminuting installation can have several comminuting devices for comminuting materials. The comminuting devices can functionally be arranged in parallel. Material discharge lines of the comminuting device can lead to at least one common conveying removal line for comminuted materials. Furthermore, exhaust air ducts of the comminuting device can lead to a common exhaust air duct. With the aid of at least one explosion control system according to the invention, the individual comminuting device can be compartmentalized in the event of an unintentional energy release. In this way, a propagation of the unintended energy release to unaffected comminuting devices can be prevented, in particular via common exhaust air ducts and/or common conveying removal lines.

Moreover, according to the invention, the task of the method is achieved in that the propagation of pressure increases, as a result of unintended releases of energy through materials in the comminuting installation, is controlled by at least one pressure control device. In this way, the consequences of an unintended energy release can be reduced.

Advantageously, at least one area of the comminuting installation, in particular at least one area in which unintended releases of energy take place, can be compartmentalized. In this way, unaffected areas of the comminuting installation can be better protected in the event of unintended releases of energy.

Additionally, or alternatively, an increase in pressure as a result of an unintended energy release can advantageously be relieved in a controlled manner. In this way, damage can be avoided.

In all other respects, the features and advantages shown in connection with the explosion control system according to the invention, the comminuting installation according to the invention, and the method according to the invention and their respective advantageous embodiments apply when the necessary changes have been made to one another and vice versa. The individual features and advantages can, of course, be combined with one another, wherein further advantageous effects can arise which go beyond the sum of the individual effects.

Further advantages, features and details of the invention will be apparent from the description which follows, in which examples of embodiments of the invention are explained in more detail with reference to the drawing. The person skilled in the art will expediently also consider the features disclosed in combination in the drawing, the description, and the claims individually and combine them to form useful further combinations.

### BRIEF DESCRIPTION OF THE DRAWINGS

The FIGURE shows a comminuting installation for materials, which has an explosion control system.

The same components are marked with the same reference signs in the figures.

### DETAILED DESCRIPTION

The FIGURE shows a comminuting installation 10 for comminuting materials as a functional representation.

The comminuting installation 10 can be used to comminute materials of, for example, plant origin, in particular wood, waste wood, straw and/or renewable agricultural products, or plastic, composite material or the like, for example, into chips, fibers, wood chips, comminuted material or the like. The comminuted materials may be used to produce material panels, for example pressboard or the like. The comminuting installation 10 can be combined, for example, with an installation (not shown) for producing material boards, in particular a press installation for producing pressed boards.

The comminuting installation 10 includes a material feeding device 12, by way of example, a plurality of comminuting devices 14, an exhaust air purification device 16, a conveying removal line 18, and an explosion control system 20. A direction of conveyance 40 of the materials in the comminuting installation 10 is indicated by arrows 40.

The material feeding device 12 is used to hold the material to be comminuted. The material is comminuted with the comminuting device 14. The exhaust air purification device 16 purifies the exhaust air from the comminuting device 14. The conveying removal line 18 transports the comminuted material, for example, to silos or to further processing machines, for example, for the production of material plates.

The material feeding device 12 comprises, for example, a silo and corresponding metering devices with which the materials to be comminuted are fed to the corresponding comminuting device 14 via the respective material supply line 22.

By way of example, the comminuting installation 10 shown in the FIGURE has two such comminuting devices 14. The comminuting devices 14 can be operated in parallel. The comminuting installation 10 can also have only one comminuting device 14 or more than two comminuting devices 14. By way of example, the comminuting devices 14 are of substantially identical construction.

Each comminuting device 14 comprises a communitor 24, by way of example, in the form of a blade ring chipper. In the direction of conveyance of the materials, the comminuting device 14 has a collection space 26 for comminuted materials downstream of the communitor 24. A conveyor 28 is arranged spatially below the collection space 26. By way of example, the comminuted materials are conveyed laterally with the conveyor 28 from the collection space 26 into an execution room 30. A compartmentalization device, by way of example, in the form of a sluice 32, is spatially connected at the bottom to the execution room 30. The sluice 32 is, by way of example, designed as an explosion-proof and flame-proof cellular wheel sluice. A material discharge line 34 leads from the sluice 32 into the conveying removal line 18. The conveying removal line 18 is, by way of example, equipped with a scraper conveyor.

Furthermore, an exhaust air duct 36 leads out of the collection space 26 of the comminuting device 14. The exhaust air ducts 36 of the comminuting device 14 lead together to the exhaust air purification device 16.

During operation of the comminuting installation 10, sparks can be generated with which comminuted materials or dust particles can be ignited. The material, in particular waste wood, may contain contaminants, for example metal or stones, which increases the risk of sparking, for example, during comminuting with the communitor 24. Dust particles are generated during comminuting of material, especially of dry materials such as waste wood. The dust particles are highly flammable. The sparks may cause an unintended energy release by materials, for example, explosions or fires. In cases of unintended energy release by materials, the comminuting installation 10 is protected and basic operation is enabled with the aid of the explosion control system 20.

The explosion control system 20 comprises a plurality of pressure control devices 42, with which the propagation of pressure increases in the comminuting installation 10 in the event of unintended releases of energy from materials can be controlled. Moreover, the explosion control system 20 includes a plurality of extinguishing devices 44, a plurality of spark detectors 46, and an explosion pressure detector 48. Further, the explosion control system 20 comprises temperature detectors, which are not shown in the FIGURE.

In addition, the explosion control system 20 comprises a control center 50 to which the components of the explosion control system 20, that are provided for this purpose, are connected as regards control and/or signal technology. The control center 50 can be used to monitor and control the explosion control system 20. Moreover, the control center 50 can be functionally connected to a control device of the comminuting installation 10. The control center 50 may also be implemented as part of or integrated into the control device of the comminuting installation 10.

A pressure control device 42a, in the form of a pressure relief device with an expansion box 52 and a rupture disc 54 is arranged at the collection space 26 of each comminuting device 14, which is to say downstream of the communitor 24, as viewed in the direction of conveyance 40 of the materials. The pressure expansion box 52 has at least one wire mesh through which a flameless pressure relief is made possible. In this manner, the expansion box 52 also acts as a pressure-guidance device by means of which pressure increases can be dissipated in a targeted manner.

Instead of one expansion box 52, several expansion boxes 52 can also be provided. Accordingly, several rupture discs 54 can also be provided.

The sluice 32 forms another pressure control device 42b in the form of a compartmentalization device. The sluice 32 is controllably connected to the control center 50. In this way, it can be closed automatically. To close the cellular wheel sluice, the cellular wheel is stopped.

A further pressure control device 42c, in the form of a compartmentalization device with a flashback blocking device 56, is provided, by way of example, as a check valve, in each exhaust air duct 36, immediately downstream of the respective collection space 26. The flashback blocking device 56 closes automatically if there is an increase in pressure in the collection space 26, for example as a result of an explosion. In this way, the pressure and any sparks are prevented from spreading via the exhaust air duct 36 and thus of reaching the exhaust air purification device 16 and/or the other comminuting device 14.

A gate valve 58 is disposed in each exhaust air duct 36 in the direction of exhaust air flow, downstream of the flashback blocking device 56. The gate valve 58 can be actuated automatically by the control center 50, or manually. The gate valve 58 can be used to close the exhaust air duct 36. For maintenance purposes, the comminuting device 14 can, for example, be separated from the rest of the comminuting installation 10 with respect to the exhaust air duct 36.

Additionally, a pressure control device 42a, or at least one expansion box 52 and/or at least one rupture disc 54 can be provided on the side of the exhaust air duct 36 facing the collection space 26. In this way, an increase in pressure can be relieved before reaching the exhaust air duct 36. Alternatively, the exhaust air duct 36 can lead out of the collection space 26 on the side on which the pressure control device 42a shown in the figure is located.

A spark detector 46 is further provided in the material discharge line 34 and the exhaust air duct 36 of each comminuting device 14.

An extinguishing device 44 is also disposed in each exhaust air duct 36. In case of spark detection in the exhaust air duct 36 by the corresponding spark detector 46, the corresponding extinguishing device 44 is activated. In so doing, an extinguishing device 44 can, for example, be used to introduce extinguishing agent into the affected exhaust air duct 36 and thus prevent further flame or spark propagation.

By way of example, two further extinguishing devices 44 are arranged on the conveying removal line 18, with which extinguishing agent can be introduced into the conveying removal line 18 if required. One of the extinguishing devices 44 is located upstream of the mouth of the first material discharge line 34 in the direction of conveyance of the conveying removal line 18. The second extinguishing device is located downstream of the second material discharge line 34 in the direction of conveyance.

A further pressure control device 42a in the form of a pressure relief device with an expansion box 52 and a rupture disc 54 is provided, by way of example, in the conveying removal line 18 between the two comminuting devices 14 shown in the FIGURE.

The explosion pressure detector 48 is arranged to detect pressure increases, for example as a result of an explosion in the comminuting installation 10.

In the event of an unintended release of energy by materials, for example sparking or an explosion, the explosion control system 20 ensures that the propagation of pressure increases in the comminuting installation 10 is controlled in such a way that the pressure increase is relieved in areas where no damage or damage that can easily be repaired is to be expected. In the process, the affected areas are compartmentalized. In this way, more sensitive areas and areas in which repairs can only be carried out with greater effort are protected from the consequences of unintended releases of energy caused by materials, for example pressure increases and/or fires, by means of the explosion control system 20. Active explosion and fire protection, for example with the aid of extinguishing agents, takes place, if necessary, only in areas of the comminuting installation 10 in which any repairs or recommissioning of the activated extinguishing devices 44 can be carried out with comparatively little effort.

If an unintentional release of energy by materials, for example an explosion, occurs in the area of a collection space 26, the resulting pressure increase is relieved by destroying the rupture disc 54 located there and relieving the pressure through the pressure expansion box 52. In addition, the sluice 32 of the corresponding comminuting device 14 is closed so that the pressure increase and any sparks cannot spread through the material discharge line 34 to the conveying removal line 18. This prevents an explosion or fire in one of the comminuting devices 14 from spreading to the other comminuting device 14.

Further, in the event of an increase in pressure in the collection space 26, the corresponding flashback blocking device 56 in the exhaust air duct 36 is automatically closed. Moreover, the exhaust air duct 36 is automatically closed by the corresponding gate valve 58, either by motor or manually. In this manner, the exhaust air from the affected comminuting device 14 is not sucked off. In the event of an explosion in the collection space 26, this exhaust air duct 36 is uncoupled.

Furthermore, one of the comminuting devices 14 with the corresponding gate valve 58 and sluice 32 can be compartmentalized for maintenance purposes from the other comminuting device 14. In this manner, the comminuting device 14 requiring maintenance is protected from unintended releases of energy from materials in other areas of the comminuting installation 10 during maintenance.

If there is an unintended release of energy by materials in the conveying removal line 18, pressure is relieved with the aid of the pressure control device 42a mounted there. The pressure is relieved by destroying the rupture disc 54 and by flameless pressure relief with the aid of the pressure expansion box 52.

If the spark detector 46 detects sparks or fire in one of the exhaust air ducts 36, the extinguishing devices 44 there are activated and the sparks or fire in the respective exhaust air duct 36 are extinguished.

In the event that spark or fire is, for example, detected with a spark detector 46 in one of the material discharge lines 34, the extinguishing devices 44 in the conveying removal line 18 are activated and the sparks or fire are extinguished. Additionally, or alternatively, when sparks or fire are detected, the conveyance in the conveying removal line 18, or the scraper conveyor, is stopped. In this way, the sparks or fire are prevented from spreading further in the conveying removal line 18 and from possibly reaching one of the other comminuting devices 14. Overall, there are a number of areas in which an increase in pressure can spread, for example, as a result of an explosion, without causing major damage, which are equipped with pressure control devices 42a in the form of pressure relief devices and pressure control devices 42b and 42c in the form of compartmentalization devices, so that pressure increases can be relieved there in a controlled manner. For example, in the event of an unintentional release of energy in a collection space 26 or in the conveying removal line 18, the areas respectively not involved, in particular the comminuting device 14 that is not involved, can be compartmentalized with the aid of the sluices 32.

10 Comminuting installation

12 Material feeding device

14 Comminuting devices

16 Exhaust air purification device

18 Conveying removal line

20 Explosion control system

22 Material supply line

24 Communitor

26 Collection space

28 Conveyor

30 Execution room

32 Sluice

34 Material discharge line

36 Exhaust air duct

38 Direction of conveyance of the materials

42a Pressure control device

42b Pressure control device

42c Pressure control device

44 Extinguishing devices

46 Spark detector

48 Explosion pressure detector

50 Control center

52 Expansion box

54 Rupture discs

56 Flashback blocking device

58 Gate valve

1.-15. (canceled)

16. An explosion control system of a comminuting installation for materials for controlling unintended releases of energy by materials, comprising:
at least one pressure control device configured to control the propagation of pressure increases due to releases of energy by materials in the comminuting installation.

17. The explosion control system according to claim 16, wherein the at least one pressure control device comprises or consists of at least one pressure relief device.

18. The explosion control system according to claim 16, wherein the at least one pressure control device comprises or consists of at least one expansion box and/or at least one rupture disc.

19. The explosion control system according to claim 16, wherein the at least one pressure control device is arranged according to one or more of the following arrangements: (i) the at least one pressure control device is arranged downstream of a comminuting device in the direction of conveyance of the materials, (ii) the at least one pressure control device is arranged upstream of, on or in a conveying removal line for comminuted materials, or (iii) the at least one pressure control device is arranged on, in or upstream of at least one exhaust air duct.

20. The explosion control system according to claim 16, wherein the at least one pressure control device comprises or consists of at least one pressure guidance device with which the pressure increase in the comminuting installation is configured to be guided in a controlled manner.

21. The explosion control system according to claim 16, wherein the at least one pressure control device comprises or consists of at least one compartmentalization device.

22. The explosion control system according to claim 16, wherein the at least one pressure control device comprises or consists of at least one compartmentalization device configured to be controlled and/or the at least one pressure control device comprises or consists of at least one automatic-acting compartmentalization device.

23. The explosion control system according to claim 16, wherein the at least one pressure control device comprises or consists of at least one sluice and/or at least one pressure control device comprises or consists of at least one flashback blocking device.

24. The explosion control system according to claim 16, wherein at least one compartmentalization device of the at least one pressure control device has one or more of the following arrangements: (i) the at least one compartmentalization device of the at least one pressure control device is arranged downstream of at least one comminuting device in the direction of conveyance of the materials, (ii) the at least one compartmentalization device of the at least one pressure control device is arranged upstream of at least one conveying removal line for comminuted materials in the direction of conveyance of the materials, (iii) the at least one compartmentalization device of the at least one pressure control device is arranged in, on or upstream of an exhaust air duct for the at least one comminuting device, or (iv) the at least one compartmentalization device of the at least one pressure control device is arranged downstream of a pressure relief device in the direction of conveyance of the materials.

25. The explosion control system according to claim 16, wherein the explosion control system comprises at least one extinguisher for extinguishing releases of energy in the form of sparks and/or fire.

26. The explosion control system according to claim 16, wherein the explosion control system comprises at least one detector configured to detect unintended releases of energy by materials.

27. The explosion control system according to claim 26, wherein the at least one detector is arranged in the vicinity of the at least one pressure control device and/or at least one extinguisher.

28. The explosion control system according to claim 16, wherein the explosion control system comprises at least one control center.

29. A comminuting installation for materials with at least one comminuting device, comprising:
at least one material supply line configured to feed materials to be comminuted to the at least one comminuting device;
at least one conveying removal line configured to permit removal of comminuted materials from the at least one comminuting device, and
at least one explosion control system configured to control unintended releases of energy by materials,
wherein the explosion control system comprises at least one pressure control device configured to control the propagation of pressure increases due to releases of energy by materials in the comminuting installation.

30. A method for operating an explosion control system of a comminuting installation for materials, in which any unintended releases of energy by materials are controlled, the method comprising:
controlling the propagation of pressure increases, as a result of unintended releases of energy by materials in the comminuting installation, by at least one pressure control device.
